(19) United States
(12) Patent Application Publication
(10) Pub. No.: US 2009/0071033 A1
(43) Pub. Date: Mar. 19, 2009

(54) DUCTLESS TYPE CLOTHES DRIER

(76) Inventors: Seung-Phyo AHN, Changwon (KR); Byeong-Jo Ryoo, Changwon (KR); Sung-Ho Song, Changwon (KR); Yang-Hwan Kim, Changwon (KR); Yoon-Seob Eom, Changwon (KR); Yang-Ho Kim, Changwon (KR); Jae-Hyuk Wee, Changwon (KR)

Correspondence Address: KED & ASSOCIATES, LLP, P.O. Box 221200, Chantilly, VA, 20153-1200, US

(21) Appl. No.: 12/203,414

(22) Filed: Sep. 3, 2008

(30) Foreign Application Priority Data
Sep. 13, 2007 (KR) 10-2007-0093289

(51) Int. Cl. F26B 11/02

(52) U.S. Cl. 34/595

(57) ABSTRACT

A ductless type clothes drier comprises: a heat pump system including a condenser configured to supply hot air into the drum, and an evaporator configured to remove moisture inside air exhausted from the drum; and a lint removing unit configured to inject water to the evaporator so that lint on the evaporator can be removed.

Accordingly, without using water, moisture included in exhausted air can be removed as a heat exchange process is performed at the evaporator. Water for removing moisture included in air does not have to be supplied to the ductless type clothes drier, thereby solving cost increase due to increase of a water consumption amount. Furthermore, since clean water remained after being used for heat exchange is not discarded, waste of water resources is prevented. Also, the conventional problem that the ductless type clothes drier has a difficulty in being commercialized due to increase of a water consumption amount is solved.

Furthermore, since the lint removing unit configured to inject water to the evaporator is provided, lint on the evaporator is removed. Accordingly, a heat exchange efficiency by the evaporator is enhanced, and a drying function of the ductless type clothes drier is more enhanced.

### RELATED APPLICATION

The present invention relates to subject matter contained in priority Korean Application No. 10-2007-0093289, filed on Sep. 13, 2007, which is herein expressly incorporated by reference in its entirety.

### BACKGROUND OF THE INVENTION

1. Field of the Invention

The present invention relates to a ductless type clothes drier.

2. Description of the Background Art

Generally, a clothes drier serves to dry clothes by blowing hot air into a drum and thereby absorbing moisture inside the clothes. The clothes drier may be largely classified into an exhausting type and a condensing type according to a method for processing air occurring when clothes are dried.

In the exhausting type clothes drier, a method for exhausting humid air discharged from a drum is used. An exhaustion duct for exhausting moisture evaporated from the drum is required. Furthermore, since carbon monoxide, etc., a byproduct after combustion is exhausted, the exhaustion duct has to be long extending up to outdoors.

In the condensing type clothes drier, air discharged from a drum is condensed by a heat exchanger of a dehumidifying unit thus to have moisture removed therefrom. Then, the air having moisture removed therefrom is re-introduced into the drum thus to be recycled. However, since the dried air flows with a closed loop, it is not easy to use gas as a heat source.

To overcome the disadvantages of the exhausting type clothes drier and the condensing type clothes drier, there is provided a ductless type clothes drier. In the ductless type clothes drier, an exhaustion duct for exhausting moisture evaporated from a drum does not have to be installed with being long-extending up to outdoors. Furthermore, since air discharged from the drum is exhausted after being dehumidified by a heat exchanger, the dried air does not have to be re-introduced into the drum for recycling.

In order to remove moisture included in air exhausted after being used to dry clothes, the ductless type clothes drier includes a heat exchanger. The heat exchanger is supplied with a large amount of water so as to remove moisture inside air that passes therethrough in a water-cooled manner. As the water supplied to the heat exchanger performs heat exchange with air that passes through the heat exchanger, moisture inside air is removed.

In the ductless type clothes drier, a large amount of water is required to remove moisture inside air in a water-cooled manner, thereby increasing costs. Furthermore, since clean water is discarded after being used for heat exchange, water resources are wasted. Also, it is difficult to commercialize the ductless type clothes drier as water consumption amount is increased.

Besides, in the ductless type clothes drier, since heat generated after a gas combustion process is utilized to heat air supplied to the drum, carbon monoxide harmful to a human's body may occur during the gas combustion process.

### SUMMARY OF THE INVENTION

Therefore, it is an object of the present invention to provide a ductless type clothes drier capable of removing moisture included in exhausted air by performing a heat exchange process without using water.

Therefore, it is another object of the present invention to provide a ductless type clothes drier capable of heating air supplied to a drum without using gas.

To achieve these and other advantages and in accordance with the purpose of the present invention, as embodied and broadly described herein, there is provided a ductless type clothes drier, comprising a heat pump system including an evaporator, a condenser, a compressor, and an expansion valve.

According to another aspect of the present invention, there is provided a ductless type clothes drier, comprising: a body; a drum rotatably installed at the body; a heat pump system including a condenser configured to supply hot air into the drum, and an evaporator configured to remove moisture inside air exhausted from the drum; and an exhaustion duct having one end connected to the evaporator, and another end exposed to outside of the body. Accordingly, moisture included in air exhausted from the drum can be removed by a heat exchange process at the evaporator without using water.

Preferably, the condenser is installed on a supply duct configured to supply external air to the drum, and the evaporator is installed on an exhaustion duct configured to exhaust air discharged from the drum.

One or more heaters configured to supply hot air into the drum are installed at front and/or rear sides of the condenser.

According to still another aspect of the present invention, there is provided a ductless type clothes drier, comprising: a body; a drum rotatably installed at the body; a heat pump system including a condenser configured to supply hot air into the drum, and an evaporator configured to remove moisture inside air exhausted from the drum; and a lint removing unit configured to inject water to the evaporator so that lint on the evaporator can be removed. Accordingly, moisture included in air exhausted from the drum can be removed by a heat exchange process at the evaporator without using water. Furthermore, lint on the evaporator is removed by the lint removing unit, thereby enhancing heat exchange efficiency of the evaporator and thus enhancing a drying function of the ductless type clothes drier.

Preferably, the lint removing unit is configured to remove lint on a front surface of the evaporator by injecting water to the evaporator after a drying process is completed.

Preferably, the lint removing unit includes a nozzle installed at a front side of the evaporator; a tube configured to supply water to the nozzle; and a valve installed at the tube.

Preferably, the nozzle is provided with injection holes for injecting water by a predetermined angle (φ), and is inclined by a predetermined angle (θ) towards a front surface of the evaporator.

Preferably, the ductless type clothes drier further comprises: a case encompassing the evaporator, and containing condensing water at a bottom surface; and a pump configured to periodically discharge the condensing water of the case.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view of a ductless type clothes drier according to a first embodiment of the present invention;

FIG. 2 is an inner layout of each component of the ductless type clothes drier of FIG. 1;

FIG. 3 is an extracted view of a heat pump system of FIG. 2;

FIG. 4 is an extracted perspective view of an evaporator, a lint removing unit, a tube for connecting the evaporator and the lint removing unit, and a pump;

FIG. 5 is a perspective view of the evaporator of FIG. 4, and a lint removing unit configured to inject water to a front surface of the evaporator; and

FIG. 6 is a side view of the evaporator of FIG. 4, and the lint removing unit configured to inject water to a front surface of the evaporator.

### DETAILED DESCRIPTION OF THE INVENTION

Reference will now be made in detail to the preferred embodiments of the present invention, examples of which are illustrated in the accompanying drawings.

Hereinafter, a ductless type clothes drier according to a first embodiment of the present invention will be explained in more detail with reference to the attached drawings.

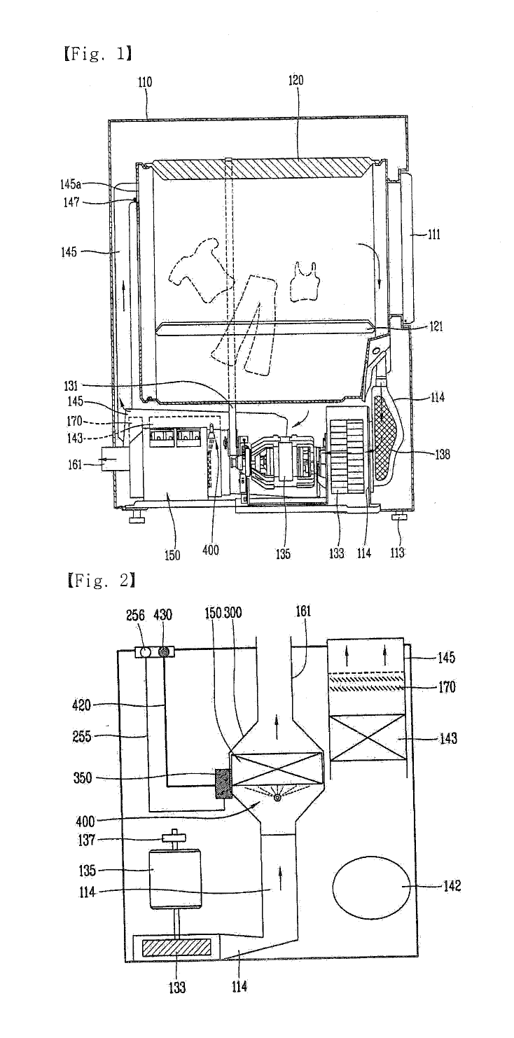

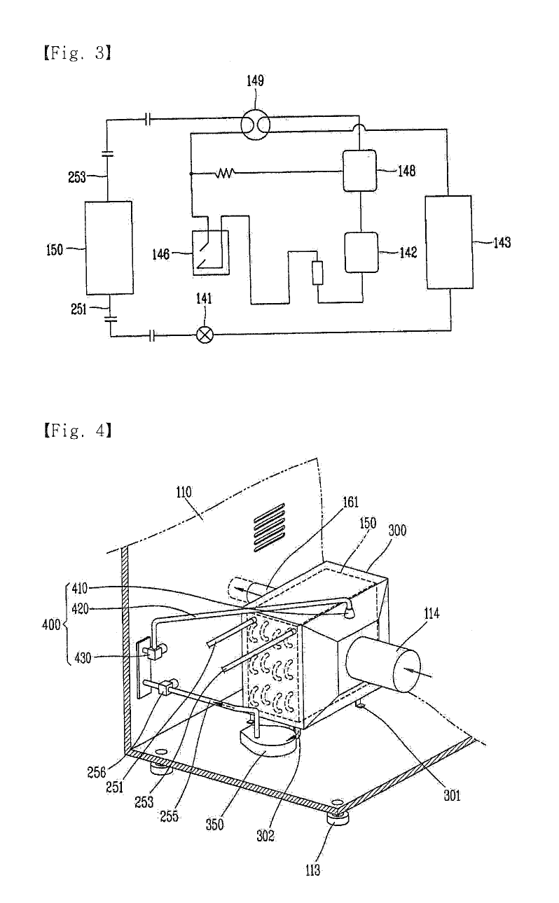

FIG. 1 is a schematic view of a ductless type clothes drier according to a first embodiment of the present invention, FIG. 2 is an inner layout of each component of the ductless type clothes drier of FIG. 1, and FIG. 3 is an extracted view of a heat pump system of FIG. 2.

Referring to FIGS. 1 and 2, the ductless type clothes drier according to a first embodiment of the present invention comprises: a body 110; a drum 120 rotatably installed at the body 110; a heat pump system including a condenser 143 configured to supply hot air into the drum 120, and an evaporator 150 configured to remove moisture inside air exhausted from the drum 120; an exhaustion duct 161 having one end connected to the evaporator 150, and another end exposed to a rear side of the body; and a lint removing unit 400 configured to inject water to the evaporator 150 so that lint on the evaporator 150 can be removed.

A door 111 through which clothes are introduced into the drum 120 is installed on a front surface of the body 110, and a foot 113 configured to support the body 110 is installed below the body 110. Inside the body 110, installed are a belt 131 configured to rotate the drum 120, a fan 133 disposed inside a circulation duct 114 that provides a blowing force by air inside the clothes, and a motor 135 configured to provide a driving force to the belt 131 and the fan 133. A pulley 137 configured to lock the belt 131 is installed on a rotation shaft of the motor 135. Here, the motor 135 may be configured in plurality in number so that a driving force can be provided to the belt 131 and the fan 133, respectively. At the circulation duct 114, installed is a filter (not shown) configured to filter lint such as nap and seam included in high temperature and high humid air exhausted from the drum 120.

The drum 120 is a box having an inner space to which an object to be dried, such as clothes, is introduced, and is provided with a plurality of lifters 121 therein configured to lift clothes. Hereinafter, an object to be dried will be called as clothes.

Referring to FIGS. 2 and 3, the heat pump system is composed of a condenser 143, a compressor 142, an expansion valve 141, an evaporator 150, and a tube connecting them to each other. The heat pump system has efficiency more enhanced than that of a clothes drier having only a heater, and prevents clothes from being damaged by high temperature air.

Hereinafter, operation of the heat pump system will be explained in more detail. Refrigerant gas discharged from the compressor 142 is separated from oil by an oil separator 148, and then is introduced into the condenser 143 via a four-way valve 149. Then, the refrigerant gas separated from oil is converted to a refrigerant of low temperature and low pressure via the expansion valve 141, and is introduced into the evaporator 150 via a tube 251.

Refrigerant gas evaporated from the evaporator 150 performs heat exchange with air that passes through the evaporator 150, and then is introduced into an accumulator 146 via a tube 253 and the four-way valve 149. Then, the refrigerant gas introduced into the accumulator 146 is sucked to the compressor 142 to consecutively circulate in the compressor 142.

The condenser 143 serves to condense refrigerant gas thereby to emit heat. Air peripheral to the condenser and heated by the emitted heat is introduced into the drum 120 through a supply duct 145, thereby drying clothes. To this end, the condenser 143 is installed on the supply duct 145 configured to supply external air to the drum 120.

A temperature sensor 147 configured to measure a temperature of air introduced into the drum 120 is installed at an outlet 145a of the supply duct 145 (refer to FIG. 1). When a temperature of air detected by the temperature sensor 147 is higher than a reference value, the heat pump system is stopped. Accordingly, clothes damage due to high temperature air is prevented.

A heater 170 configured to additionally supply heat to air when heat emitted from the condenser 143 is not sufficient may be installed at a rear side of the condenser 143. The heater may be installed in plurality in number, and may be installed at a front side of the condenser 143, and so on.

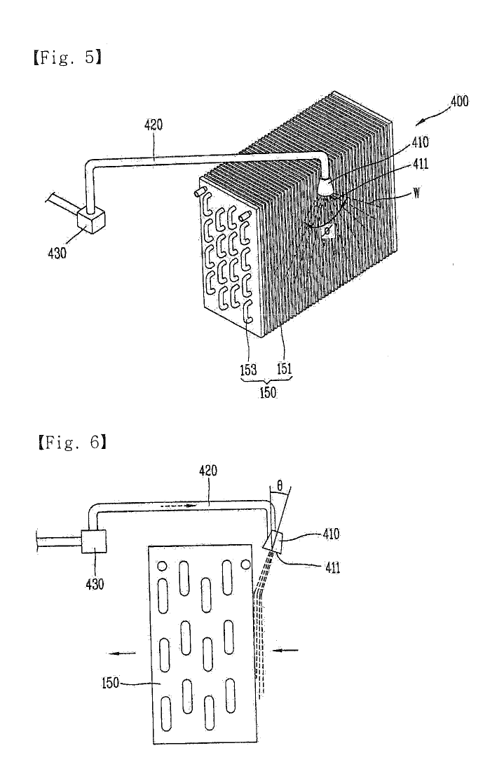

FIG. 4 is an extracted perspective view of an evaporator, a lint removing unit, a tube for connecting the evaporator and the lint removing unit, and a pump; FIG. 5 is a perspective view of the evaporator of FIG. 4, and a lint removing unit configured to inject water to a front surface of the evaporator; and FIG. 6 is a side view of the evaporator of FIG. 4, and the lint removing unit configured to inject water to a front surface of the evaporator.

Referring to FIGS. 4 and 5, the evaporator 150 is composed of fins 151 and refrigerant tubes 153 along which refrigerant flows. High temperature and high humidity air exhausted from the drum 120 (refer to FIG. 1) is condensed thus to be in a dried state.

That is, refrigerant gas flowing along the refrigerant tubes 153 of the evaporator 150 absorbs peripheral heat while being evaporated. Here, moisture included in air passing through the evaporator 150 is condensed thus to be separated from the air. Accordingly, water for removing moisture included in air does not have to be supplied to the ductless type clothes drier at all.

The fins 151 are implemented as a plurality of metallic thin plates having an excellent conductivity are laminated to each other with a minute gap therebetween so as to vertically contact and pass high temperature and high humid air.

The refrigerant tubes 153 have refrigerant gas circulating therein, and penetrate the fins 151 in a zigzag manner. A tube 251 configured to introduce refrigerant discharged from the expansion valve 141 (refer to FIG. 3) to the refrigerant tubes 153 is connected to an inlet of the refrigerant tubes 153.

The tube 253 configured to introduce a refrigerant discharged from the refrigerant tubes 153 to the four-way valve 149 (refer to FIG. 3) is connected to an outlet of the refrigerant tubes 153.

The evaporator 150 is covered by a case 300. The case 300 is installed to have a predetermined height from a bottom surface of the body 110 by a case supporting pin 301.

An inlet of the case 300 is connected to the drum 120 (refer to FIG. 1) by the circulation duct 114, and an outlet of the case 300 is connected to the exhaustion duct 161.

Humid air introduced into the inlet of the case 300 is dehumidified via the evaporator 150, and then is exhausted through the exhaustion duct 161 connected to the outlet of the case 300.

Here, moisture (condensing water) separated from air while passing through the evaporator 150 is contained at the bottom of the case 300.

When a pump 350 is operated, the condensing water is discharged out through a tube 302 for connecting a bottom surface of the case 300 and the pump 350, and through a tube 225 for connecting the pump 350 and an external drain opening (not shown). A valve 256 is installed at the tube 255 thus to open and close the tube 255. As the valve 255, a solenoid valve may be used.

The lint removing unit 400 includes a nozzle 410 installed at a front side of the evaporator 150, a tube configured to supply water to the nozzle 410, and a valve 430 installed at the tube 420. The lint removing unit 400 injects water to the evaporator 150 when a drying process is completed, not during a drying process. Since lint on the surface of the evaporator 150 is removed at one time, lint removing efficiency is enhanced. Furthermore, since water for removing lint does not have to be continuously supplied to the surface of the evaporator 1 150, a water consumption amount is reduced.

Referring to FIGS. 5 and 6, injection holes 411 configured to inject water are formed at a lower surface of the nozzle 410. The injection holes 411 serve to inject water by a predetermined angle (Θ). In the preferred embodiment, the injection holes 411 serve to inject water by 100°˜120°. The nozzle 410 is inclined by a predetermined angle (Θ) towards a front surface of the evaporator 150 so that water can be injected to the front surface of the evaporator 150. In the preferred embodiment, the nozzle 410 is inclined by 20°˜30°. Accordingly, water from the nozzle 410 is injected to the front surface of the evaporator 150, thereby removing lint. Also, water injected from the nozzle 410 flows down along a front surface of the evaporator 150, thereby removing lint. Here, the valve 430 (refer to FIG. 3). Here, the valve 430 (refer to FIG. 3) opens the tube 420 thus to supply water to the nozzle 410.

Referring to FIG. 4, the removed lint is collected to the bottom of the case 300 together with water. The collected lint is discharged out through the tubes 302 and 255 when the pump 350 is operated. Here, the valve 256 opens the tube 255. Since lint on the evaporator 150 is removed, a heat exchange efficiency by the evaporator 150 is enhanced, and a drying function of the ductless type clothes drier is more enhanced.

In the ductless type clothes drier according to the present invention, moisture included in exhausted air can be removed as a heat exchange process is performed in the evaporator. Accordingly, water for removing moisture included in air does not have to be supplied to the ductless type clothes drier, thereby solving cost increase due to increase of a water consumption amount. Furthermore, since clean water remained after being used for heat exchange is not discarded, waste of water resources is prevented. Also, the conventional problem that the ductless type clothes drier has a difficulty in being commercialized due to increase of a water consumption amount is solved.

Furthermore, since air supplied to the drum is heated by heat occurring from the condenser without using gas, carbon monoxide harmful to a human's body is prevented from occurring.

Furthermore, since the lint removing unit configured to inject water to the evaporator is provided, lint on the evaporator is removed. Accordingly, a heat exchange efficiency by the evaporator 150 is enhanced, and a drying function of the ductless type clothes drier is more enhanced.

The foregoing embodiments and advantages are merely exemplary and are not to be construed as limiting the present invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A ductless type clothes drier, comprising:
a heat pump system including an evaporator, a condenser, a compressor, and an expansion valve.

2. A ductless type clothes drier, comprising:
a body;
a drum rotatably installed at the body;
a heat pump system including a condenser configured to supply hot air into the drum, and an evaporator configured to remove moisture inside air exhausted from the drum; and
an exhaustion duct having one end connected to the evaporator, and another end exposed to outside of the body.

3. The ductless type clothes drier of claim 2, wherein the condenser is installed on a supply duct configured to supply external air to the drum.

4. The ductless type clothes drier of claim 3, wherein a temperature sensor configured to measure a temperature of air introduced into the drum is installed at an outlet of the supply duct.

5. The ductless type clothes drier of claim 2, wherein the evaporator is installed on an exhaustion duct configured to exhaust air discharged from the drum.

6. The ductless type clothes drier of claim 2, wherein one or more heaters configured to supply hot air into the drum are installed at front and/or rear sides of the condenser.

7. A ductless type clothes drier, comprising:
a body;
a drum rotatably installed at the body;
a heat pump system including a condenser configured to supply hot air into the drum, and an evaporator configured to remove moisture inside air exhausted from the drum; and
a lint removing unit configured to inject water to the evaporator so that lint on the evaporator can be removed.

8. The ductless type clothes drier of claim 7, wherein the lint removing unit is configured to inject water to the evaporator after a drying process is completed.

9. The ductless type clothes drier of claim 7, wherein the lint removing unit is configured to remove lint on a front surface of the evaporator.

10. The ductless type clothes drier of claim 7, wherein the lint removing unit includes:
a nozzle installed at a front side of the evaporator;
a tube configured to supply water to the nozzle; and
a valve installed at the tube.

11. The ductless type clothes drier of claim 10, wherein the nozzle is provided with injection holes for injecting water by a predetermined angle (φ).

12. The ductless type clothes drier of claim 11, wherein the predetermined angle (φ) is in a range of 100°˜120°.

13. The ductless type clothes drier of claim 10, wherein the nozzle is inclined by a predetermined angle (Θ) towards a front surface of the evaporator.

14. The ductless type clothes drier of claim 13, wherein the predetermined angle (Θ) is in a range of 20°˜30°.

15. The ductless type clothes drier of claim 7, further comprising:
a case encompassing the evaporator, and containing condensing water;
a pump configured to provide a pumping force for periodically discharging the condensing water;
a tube configured to connect the case and the pump to each other; and
a valve installed on the valve, and configured to open and close the tube.
